(19) United States
(12) Patent Application Publication
(10) Pub. No.: US 2026/0295600 A1
(43) Pub. Date: Oct. 1, 2026

(54) A CENTRIFUGAL SEPARATOR

(71) Applicant: Alfa Laval Corporate AB, LUND (SE)

(72) Inventors: Per-Gustaf LARSSON, HUDDINGE (SE); Anders EKSTRÖM, TÄBY (SE); Kasper HÖGLUND, RÖNNINGE (SE); Daniel ELIASSON, ÄLVSJÖ (SE)

(73) Assignee: Alfa Laval Corporate AB, LUND (SE)

(21) Appl. No.: 19/477,632

(22) PCT Filed: May 6, 2024
(86) PCT No.: PCT/EP2024/062414

§ 371 Date: Oct. 22, 2025

(30) Foreign Application Priority Data
May 17, 2023 (EP) 23173872.5

(51) Int. Cl. B04B 7/08; B04B 1/08; B04B 11/02

(52) U.S. Cl. CPC B04B 7/08; B04B 1/08; B04B 11/02

(57) ABSTRACT

The present invention provides a centrifugal separator for separating at least one liquid phase from a liquid feed mixture, comprising a stationary frame, a drive member and a rotating part, wherein the drive member is configured to rotate the rotatable part in relation to the stationary frame around an axis of rotation, and wherein the rotatable part comprises a centrifuge bowl enclosing a separation space; wherein the centrifugal separator further comprises a mechanical seal for sealing between the rotatable part and the stationary frame during operation, the mechanical seal comprising a rotatable sealing ring connected to the rotatable part, a stationary sealing ring connected to the stationary frame; wherein the rotatable sealing ring comprises at least one first sealing surface and the stationary sealing ring comprises at least one second sealing surface, which sealing surfaces having a contact force between each other and forming at least one sealing interface between the rotatable and the stationary sealing rings during operation.

### FIELD OF THE INVENTION

The present invention relates to the field of centrifugal separators, and more specifically to seals for centrifugal separators.

### BACKGROUND OF THE INVENTION

Centrifugal separators are generally used for separation of liquids and/or solids from a liquid mixture or a gas mixture. During operation, fluid mixture that is about to be separated is introduced into a rotating bowl and due to the centrifugal forces, heavy particles or denser liquid, such as water, accumulates at the periphery of the rotating bowl whereas less dense liquid accumulates closer to the central axis of rotation. This allows for collection of the separated fractions, e.g. by means of different outlets arranged at the periphery and close to the rotational axis, respectively.

The stationary inlet and outlet pipes of high-speed separators are sealed in relation to the rotatable part of the separator. The seal may be a hermetic seal, such as a mechanical hermetic seal, which is used when the material to be separated in the centrifugal separator should not be exposed to or come in contact with the atmosphere. Thus, a hermetic seal reduces the risk of any substance, such as oxygen, or particles in the atmosphere from contaminating the liquid fed or a separated phase.

There are challenges to keep hermetic seals tightly sealed due to impacting parameters in the surrounding environment. As an example, in brewery applications, separated yeast may penetrate gaps in the sealing and replace the sealing liquid. This leads to a reduced sealing functionality.

Sealing liquid is conventionally used to cool and lubricate hermetic seals. A certain pressure to the seal is applied by the sealing liquid.

There is thus a need in the art for improved mechanical hermetic seals.

### SUMMARY OF THE INVENTION

A main object of the present invention is to provide a centrifugal separator having an improved sealing function to regulate the contact force not only by means of a sealing liquid and that also is suitable when separating highly concentrated fluids, such as a liquid comprising yeast.

As a first aspect of the invention, there is provided a centrifugal separator for separating at least one liquid phase from a liquid feed mixture, comprising a stationary frame, a drive member and a rotating part, wherein the drive member is configured to rotate the rotatable part in relation to the stationary frame around an axis of rotation (X), and wherein the rotatable part comprises a centrifuge bowl enclosing a separation space; wherein the centrifuge bowl further comprises an inlet for receiving the liquid feed mixture and at least one liquid outlet for discharging a separated liquid phase; wherein the centrifugal separator further comprises a mechanical seal for sealing between the rotatable part and the stationary frame during operation, the mechanical seal comprising a rotatable sealing ring connected to the rotatable part, a stationary sealing ring connected to the stationary frame; wherein the mechanical seal provides a seal between an inner zone and an outer zone and wherein the inner zone is located radially inside and extends axially through the sealing rings and the outer zone is arranged radially outside the sealing rings; wherein the rotatable sealing ring comprises at least one first sealing surface and the stationary sealing ring comprises at least one second sealing surface, which sealing surfaces having a contact force between each other and forming at least one sealing interface between the rotatable and the stationary sealing rings during operation; and wherein the mechanical seal is arranged in the separator such that said contact force of the mechanical seal is actively dynamically adjustable in a substantially axial direction during operation.

The drive member may be a drive motor, such as an electric motor.

As used herein, the term “axially” denotes a direction which is parallel to a first rotational axis (X). Accordingly, relative terms such as “above”, “upper”, “top”, “below”, “lower”, and “bottom” refer to relative positions along the first rotational axis (X). Correspondingly, the term “radially” denotes a direction extending radially from the first rotational axis (X). A “radially inner position” thus refers to a position closer to the first rotational axis (X) compared to “a radially outer position”. A radial plane is a plane having its normal parallel to the first axis of rotation (X). An axial plane is a plane having its normal perpendicular to the first axis of rotation (X).

The separation space of the centrifuge bowl is where the liquid feed mixture is separated into at least one liquid phase that is led out via at least one liquid outlet. The liquid feed mixture may be separated into a liquid heavy phase that is discharged through one outlet and into a liquid light phase that is discharged through another outlet. Possibly, also solids or a sludge phase is separated from the liquid feed mixture.

The mechanical seal may be a hermetic seal, i.e. a seal that provides for an airtight seal.

The sealing interface is the interface between the sealing surface of the rotatable sealing ring and the sealing surface of the stationary sealing. During normal operation, the sealing interface may have an axial height of a few um and may comprise a sealing or cooling liquid that decreases the friction between the sealing surfaces. The sealing surfaces may be substantially radially aligned with each other in order to have substantially the same radial extension.

The contact force being “dynamically adjustable during operation” means that during operation, the contact force may be actively adjusted by e.g. an operator so as to adapt to different operating conditions. As an example, the contact force may be adjusted so that the sealing surfaces of the rotatable and the stationary sealing rings has a tight fit or a less tight fit. A tight fit means that there is a higher contact force between the sealing surfaces and when there is a less tight fit the contact force has a lower value. The contact force may be directed mainly in an axial direction.

The first aspect of the invention is based on the insight that in certain applications, it is an advantage to be able to adjust the contact force between the sealing rings of a mechanical seal during operation of a centrifugal separator. And that the adjustment of the contact force not only relies on pressure applied by sealing liquid. The control of the resulting force can be used to control the closing pressure of the mechanical seal which in turn could greatly reduce power consumption. Also adjusting the contact force may be used for opening/lifting the sealing rings of the mechanical seal during operation, so that the mechanical seal itself may function as an alternative outlet for a separated liquid phase.

As an example, in separators where yeast is the solid phase to be separated, e.g. when using separators in breweries, it is challenging to handle highly concentrated and highly viscous fluids. Often the yeast penetrates gaps in the mechanical seal and replaces the sealing liquid, such as a water film, which is needed for proper functioning. However, yeast do not have the relevant properties to maintain an even film for the sealing, so instead the seal would leak, resulting in loss of process control. By dynamically adjusting the contact force of the mechanical seal in a substantially axial direction, an increased downward force may compensate against any experienced upward force in the mechanical seal, thereby decreasing the risk of separated yeast replacing the sealing liquid.

The inventors have thus found that it is advantageous to be able to regulate the force being applied to the mechanical seal so that the pressure applied to the mechanical seal is at an appropriate level throughout the operation. The force applied may be actively dynamically adjustable during operation. By actively is meant that the contact force applied may be regulated independently from the forces experienced by the mechanical seal from the sealing liquid, the liquid feed mixture or any separated liquid phase. By dynamically is meant that the contact force applied may vary throughout operation and thereby not being static over time during normal operation.

In embodiments of the first aspect, the centrifugal separator further comprises a pressurizable compartment being arranged axially in relation to the sealing rings and wherein the pressurizable compartment is arranged for transmitting a pressure force to the stationary sealing ring such that the contact force between the sealing surfaces is actively dynamically adjustable during operation. This leads to direct control of the contact force in order to be able to adjust the force during operation. Moreover, twisting of the seal can be controlled. The pressurizable compartment may be arranged axially above the stationary sealing ring and may be an enclosure that is able to define a specific pressure that may act on the stationary sealing ring.

In embodiments of the first aspect, a liquid outlet defines the inner zone and a volume outside the centrifuge bowl defines the outer zone. The mechanical seal may thus be an outlet seal, such as an outlet seal arranged for sealing the liquid heavy phase outlet. The volume outside the centrifuge bowl may be a volume under a stationary hood that covers the centrifuge bowl. Thereby sealing between either separated liquid heavy phase or separated liquid light phase and the surroundings may be achieved. The mechanical seal may be arranged at the top of the centrifuge bowl. The pressure force applied to the seal by the pressurizable compartment may be larger than the forces experienced by the mechanical seal from the inner zone.

In embodiments of the first aspect, the centrifuge bowl has a first liquid outlet for discharging a liquid heavy phase and a second liquid outlet for discharging a liquid light phase, and wherein the second liquid outlet defines the inner zone and the first liquid outlet defines the outer zone. This results in sealing between liquid heavy phase and liquid light phase. The mechanical seal may be arranged at the top of the bowl.

In embodiments of the first aspect, both the inner zone and the outer zone form part of a liquid passage, and wherein the mechanical seal is arranged such that the contact force between the sealing surfaces is dynamically adjusted to form an axial gap to allow liquid in the inner zone to be discharged through said gap to the outer zone. Thereby an efficient cleaning of the seal might be achieved. As an example, during a cleaning-in-place (CIP) process, the liquid used for cleaning may be supplied via the gap in the mechanical seal or be discharged via the gap in the mechanical seal. The formed axial gap could also be used as an alternative outlet either for the liquid heavy phase or the liquid light phase.

The inner zone may also be part of an inlet, i.e. the mechanical seal may form an inlet seal. Thus, the inner zone may form part of an inlet and the outer zone may for example form part of a liquid outlet or a part outside the centrifuge bowl.

In embodiments of the first aspect, the rotatable part comprises a drive spindle having an inlet channel for supply of said liquid feed mixture to said inlet, and wherein the inner zone is the inlet channel and the outer zone is a volume outside the drive spindle. Thereby sealing between the feed mixture of the inlet and the surroundings may be achieved. The sealing may be arranged at the lower part of the bowl.

In embodiments of the first aspect the mechanical seal further comprises a sealing liquid chamber at the sealing interface, and wherein the centrifugal separator further comprises a sealing liquid channel for supply of sealing liquid to said sealing liquid chamber. Thereby appropriate feed of sealing liquid to the seal may be ensured. The sealing liquid may for example be water and may provide a liquid film at the interface thereby decreasing the friction between the rotatable and stationary sealing rings. The sealing liquid chamber may be arranged in the stationary sealing ring, in the rotatable sealing ring or in both. As an alternative, the sealing liquid chamber may be arranged radially outside the stationary and/or rotatable sealing rings.

Sealing liquid and a reservoir (chamber) connected thereto is conventionally used in relation to mechanical seals. The mechanical seal is opened wider by applying a higher pressure from the sealing liquid, and by applying a lower pressure from the sealing liquid the mechanical seal is opened to a smaller extent. This is a conventional way of regulating how much the seal is opened.

As an example, the sealing liquid channel is separate from the pressurizable compartment and its connection to a pressure source. Thereby the controlling of the applied force to the seal may be handled independently of feeding of sealing liquid, i.e. feeding of the sealing liquid and the pressure applied to the seal is independently controlled.

In embodiments of the first aspect, the sealing liquid chamber is arranged in the second sealing surface at the sealing interface and radially within the stationary sealing ring such that a double contact seal is formed by the rotatable and stationary sealing rings. A double contact seal refers to that the surface of the stationary sealing ring is “split” by the sealing liquid chamber, resulting in an inner and an outer surface part, i.e. two contact surfaces defining the double contact seal.

This may result in an even distribution of sealing liquid that may lead to a longer lifetime of the seal.

In embodiments of the first aspect, the stationary sealing ring comprises a side surface forming an angle with the second sealing surface, and wherein the sealing liquid channel is arranged within the stationary sealing ring and comprises an inlet and an outlet to the stationary sealing ring, and wherein the inlet and/or outlet is arranged in the side surface. By leading the sealing liquid in and/or out of the stationary sealing ring in a side surface that forms an angle with the second sealing surface may lead to sufficient space for an enclosed pressurizable compartment above the stationary sealing ring in an axial direction. The sealing liquid may thus be led to or from the stationary sealing ring in a radial direction. In embodiments of the first aspect, the sealing liquid channel is arranged radially outside of the stationary sealing ring. This may give ample space for the pressurizable compartment that may be arranged axially above the stationary sealing ring. In embodiments of the first aspect, the sealing liquid channel is arranged axially outside of the stationary sealing ring. Thereby the sealing liquid may be led to or from the stationary sealing ring in an axial direction, this may be done in a tightly sealed connection through the pressurizable compartment. By having an axial extension of the sealing liquid channel, the risk of distortion and twisting of the mechanical seal is heavily diminished.

In embodiments of the first aspect, the centrifugal separator further comprises a spring arranged in force transmitting connection to both the pressurizable compartment and said stationary sealing ring, and wherein the spring is arranged to move in an axial direction to adjust the contact force between the sealing surfaces. The spring may move jointly with the stationary sealing ring in an axially direction either downward or upward depending on if there is positive or negative pressure in the pressurizable compartment. This results in the transmitted contact force being directed mainly in an axial direction.

In embodiments of the first aspect, the centrifugal separator further comprises a pressure source that is connected to the pressurizable compartment. The pressure source may feed pressurized media or fluid to the pressurizable compartment, which further may transmit a pressure force to the stationary sealing ring.

As an example, the media of the pressure source may be a gas or a liquid for pressurizing the compartment. The pressurized media may be air.

In embodiments of the first aspect, the centrifugal separator further comprises a negative pressure generator that is connected to the pressurizable compartment. The negative pressure generator may be a vacuum pump so that the contact force may be adjusted during operation. Applying a negative pressure in the pressurizable compartment may thus decrease the contact force between the sealing surfaces. In this way the sealing surfaces may be separated by a pressure force acting in an axially upward direction on the stationary sealing ring, thereby increasing any axial gap formed between the sealing surfaces.

As a second aspect of the invention, there is provided a method for separating at least one liquid phase from a liquid feed mixture, comprising the steps of
a) introducing the liquid feed mixture into a centrifugal separator according to the first aspect of the invention,
b) discharging at least one liquid phase from the centrifugal separator; and
c) dynamically adjusting the contact force between the sealing surfaces of the mechanical seal during operation of the separator.

This aspect may generally present the same or corresponding advantages as the former aspect. Effects and features of this second aspect are largely analogous to those described above in connection with the first aspect. Embodiments mentioned in relation to the first aspect are largely compatible with the second aspect.

In embodiments of the second aspect, step c) comprises introducing pressurized gas or liquid into a pressurizable compartment arranged for transmitting a pressure force to the stationary sealing ring of the mechanical seal. The pressurized gas may be air.

In embodiments of the second aspect, step c) comprises creating a negative pressure.

In embodiments of the second aspect, wherein step c) comprises adjusting the contact force to form an axial gap between the sealing surfaces, and step b) comprises discharging a liquid phase through the gap.

In embodiments of the second aspect, the method further comprising the steps of
d) stopping the flow of liquid feed mixture,
e) adjusting the contact force to form an axial gap between the sealing surfaces; and
f) introducing a cleaning liquid into the gap.

In embodiments of the second aspect, the liquid feed mixture comprises yeast.

### BRIEF DESCRIPTION OF THE DRAWINGS

FIG. 1 shows a schematic drawing of a centrifugal separator.

FIG. 2 shows a schematic drawing of a centrifuge bowl with inlet and outlets.

FIG. 3a shows a cross section of an embodiment of a seal at an outlet.

FIG. 3b shows a cross section of a further embodiment of a seal at an outlet.

FIG. 4 shows a cross section of a further embodiment of a seal at an outlet.

FIG. 5 shows a cross section of a further embodiment of a seal at an outlet.

FIG. 6 shows a cross section of a further embodiment of a seal at an inlet.

### DETAILED DESCRIPTION

The centrifugal separator according to the present disclosure will be further illustrated by the following description with reference to the accompanying drawings.

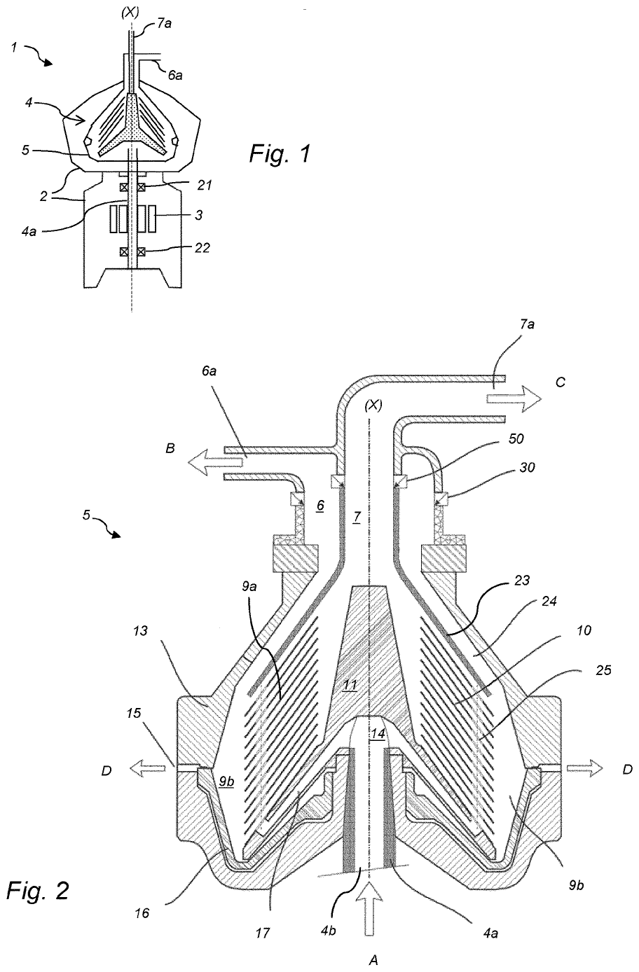

FIGS. 1 and 2 schematically show a centrifugal separator and the centrifuge bowl of the centrifugal separator of the present disclosure.

FIG. 1 shows a cross-section of an embodiment of a centrifugal separator 1 configured to separate a heavy phase and a light phase from a liquid feed mixture. The centrifugal separator 1 has a rotatable part 4, comprising the centrifuge bowl 5 and drive spindle 4a.

The centrifugal separator 1 is further provided with a drive motor 3. This motor 3 may for example comprise a stationary element and a rotatable element, which rotatable element surrounds and is connected to the spindle 4a such that it transmits driving torque to the spindle 4a and hence to the centrifuge bowl 5 during operation. The drive motor 3 may be an electric motor. Alternatively, the drive motor 3 may be connected to the spindle 4a by transmission means such as a drive belt or the like, and the drive motor may alternatively be connected directly to the spindle 4a.

The centrifuge bowl 5, shown in more detail in FIG. 2, is supported by the spindle 4a, which is rotatably arranged in a stationary frame 2 around the vertical axis of rotation (X) in a bottom bearing 22 and a top bearing 21. The stationary frame 2 surrounds the centrifuge bowl 5.

In the centrifugal separator as shown in FIG. 1, liquid feed mixture to be separated is fed to the bottom to the centrifuge bowl 5 via the drive spindle 4a. The drive spindle 4a is thus in this embodiment a hollow spindle, through which the feed is supplied to the centrifuge bowl 5. However, in other embodiments, the liquid feed mixture to be separated is supplied from the top, such as through a stationary inlet pipe extending into the centrifuge bowl 5.

After separation has taken place within the centrifuge bowl 5, separated liquid heavy phase is discharged through stationary outlet pipe 6a, whereas separated liquid light phase is discharged through stationary outlet pipe 7a.

FIG. 2. shows a more detailed view of the centrifuge bowl 5 of the centrifugal separator 1.

The centrifuge bowl 5 forms within itself a separation space 9a and a sludge space 9b, located radially outside the separation space 9a. In the separation space 9a, a stack 10 of separation discs is arranged coaxially around the axis of rotation (X). The stack 10 is arranged to rotate together with the centrifuge bowl 5 and provides for an efficient separation of the liquid feed mixture into at least a liquid light phase and a liquid heavy phase. Thus, in the separation space 9a, the centrifugal separation of the liquid feed mixture takes place during operation. The sludge space 9b is in this embodiment confined between an inner surface of the centrifuge bowl 5 and an axially movable operating slide 16.

The disc stack 10 is arranged under top disc 23 and is further supported at its axially lowermost portion by distributor 11. The distributor 11 comprises an annular conical base portion arranged to conduct liquid mixture from the center inlet 14 of the centrifuge bowl 5 to a predetermined radial level in the separation space 9a, and a central neck portion extending upwards from the base portion.

The centrifuge bowl 5 further comprises an inlet 14 in the form of a central inlet chamber formed within or under the distributor 11. The inlet 14 is arranged for receiving the liquid feed mixture and is thus in fluid communication with the hollow interior 4b of the spindle 4a, through which the liquid feed is supplied to the centrifuge bowl 5.

The inlet 14 communicates with the separation space 9a via passages 17 formed in the base portion of the distributor 11. The passages 17 may be arranged so that liquid mixture is transported to a radial level that corresponds to the radial level of the cut-outs 25 provided in the separation discs of the stack 10. The cut-outs 25 form axial channels within the disc stack and distributes the liquid feed mixture throughput the disc stack 10.

The radially outer portion of the disc stack 10 communicates via a first liquid outlet chamber 6 via channels 24 for discharge of a liquid heavy phase axially over the top disc 23.

The radially inner portion of the disc stack 10 communicates with a second outlet chamber 7 for a separated light phase of the liquid feed mixture. The second outlet chamber 7 of the centrifuge bowl 5 communicates with a stationary outlet pipe 7a for discharging the separated liquid light phase from the centrifuge bowl 5.

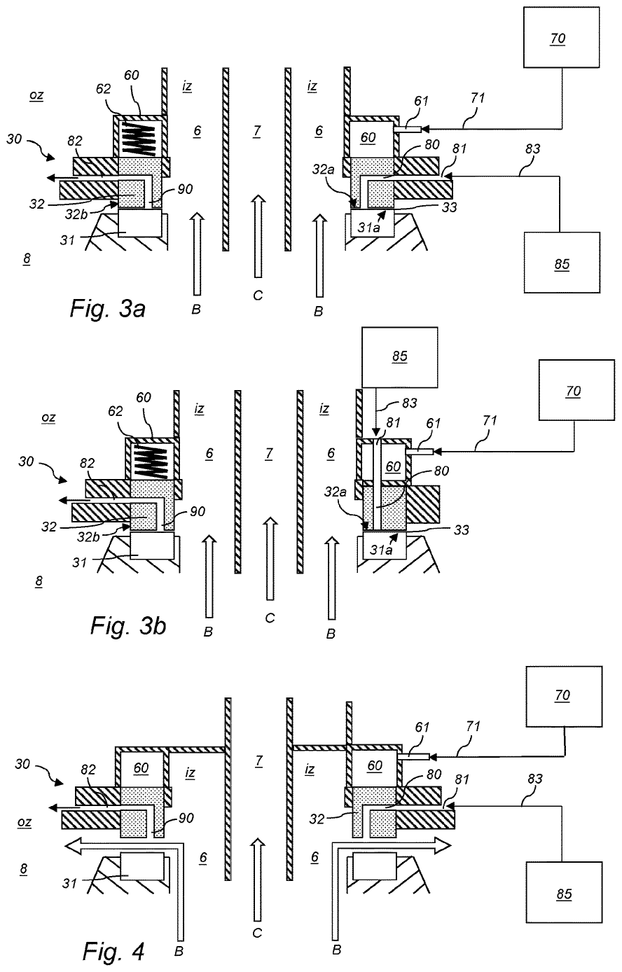

Mechanical seals 30 and 50 seal the first and second outlet chambers 6, 7, respectively. Further embodiment of mechanical seal 40 seals the inlet 14. The mechanical seal will be further discussed in relation to FIGS. 3-6 below. As this is an airtight design, they are also often called hermetic seals. The inlet channel 4b is also sealed at lower end of the hollow spindle 4a, thus preventing communication between the inlet channel 4b and the surroundings. The mechanical seal at the inlet is not shown in FIG. 2.

The centrifuge bowl 5 is further provided with outlets 15 at the radially outer periphery of the sludge space 9b. These outlets 15 are evenly distributed around the rotor axis (X) and are arranged for intermittent discharge of a sludge component of the liquid feed mixture. The sludge component comprises denser particles forming a sludge phase. The opening of the outlets 15 is controlled by means of an operating slide 16 actuated by operating water channels below the operating slide 16, as known in the art. In its position shown in the drawing, the operating slide 16 abuts sealingly at its periphery against the upper part of the centrifuge bowl 5, thereby closing the sludge space 9b from connection with outlets 15, which are extending through the centrifuge bowl 5. The centrifuge bowl 5 is defined by a surrounding outer wall 13.

During operation of the separator as shown in FIGS. 1 and 2, the centrifuge bowl 5 is brought into rotation by the drive motor 3. Via the spindle 4a, liquid feed mixture to be separated is brought into the separation space 9a, as indicated by arrow “A”. Depending on the density, different phases in the liquid feed mixture is separated between the separation discs of the stack 10. Heavier component, such as a liquid heavy phase and a sludge phase, move radially outwards between the separation discs of the stack 10 to the sludge space 9b, whereas the phase of lowest density, such as a liquid light phase, moves radially inwards between the separation discs of the stack 10 and is forced through the outlet pipe 7a via the second outlet chamber 7, as indicated by arrow “C”. The liquid of higher density is instead discharged over the top disc 23 via discharge channels 24 to the first outlet chamber 6 and further out via stationary outlet pipe 6a, as indicated by arrow “B”. Thus, during separation, an interphase between the liquid of lower density and the liquid of higher density is formed in the centrifuge bowl 5, such as radially within the stack of separation discs. Solids, or sludge, accumulate at the periphery of the sludge space 9b and is emptied intermittently from within the centrifuge bowl by the sludge outlets 15 being opened, whereupon sludge and a certain amount of fluid is discharged from the separation chamber by means of centrifugal force, as indicated by arrow “D”. However, the discharge of sludge may also take place continuously, in which case the sludge outlets take the form of open nozzles and a certain flow of sludge and/or heavy phase is discharged continuously by means of centrifugal force.

FIG. 3a shows the mechanical seal 30 arranged in connection to the outlet chambers 6, 7 at the top of the centrifuge bowl 5. The mechanical seal 30 comprises a rotatable sealing ring 31 that is connected to the rotatable part 4 (see FIGS. 1 and 2) and a stationary sealing ring 32 that is connected to the stationary frame 2 (see FIGS. 1 and 2). The sealing is arranged to seal between an inner zone, iz, defined by the outlet chambers 6 and an outer zone, oz, defined by a volume 8 outside the bowl 5. The inner zone is located radially inside and extends axially through the sealing rings 31, 32 and the outer zone is arranged radially outside the sealing rings 31, 32. Liquid of higher density, indicated by arrow “B”, is discharged via the first outlet chamber 6 and liquid of lighter density, indicated by arrow “C”, is discharged via the second outlet chamber 7. In the centrifugal separator 1 of FIGS. 1 and 2, the liquid feed mixture to be separated is fed from the bottom. However, it should be understood that the seal 30 may also be used in a top fed separator. In such a setup, the inlet feed mixture would be supplied via channel 7 as illustrated in FIG. 3a and therefore, the arrow “C” would point in the opposite direction.

The rotatable sealing ring 31 has a first sealing surface 31a facing a second sealing surface 32a of the stationary sealing ring 32. The sealing surfaces 31a, 32a have a contact force between each other. A sealing interface 33 is formed between the rotatable and the stationary sealing rings 31, 32.

A pressurizable compartment 60 is arranged for transmitting a pressure force to the stationary sealing ring 32. The compartment 60 is arranged above and in close contact with the stationary sealing ring 32. Thereby the contact force between the sealing surfaces 31a, 32a is achieved and is actively dynamically adjustable during operation. The stationary sealing ring 32 has a side surface 32b that forms an angle with the second sealing surface 32a.

A pressure source 70 is connected to the pressurizable compartment 60 via connection line 71 leading to an inlet 61 of the compartment 60. The pressure source 70 may be arranged radially outside of the pressurizable compartment 60. The pressure source 70 contains media that is a gas or a liquid in order to be able to pressurize the compartment 60. Typically, the media is air.

The sealing liquid chamber 90 is arranged at the second sealing surface 32a, at the sealing interface 33 and radially within the stationary sealing ring 32 such that a double contact seal is formed by the rotatable and stationary sealing rings 31, 32, and wherein the chamber 90 is connected to the sealing liquid channel 80.

The sealing liquid channel 80 is arranged within the stationary sealing ring 32 and comprises an inlet 81 and an outlet 82 to the stationary sealing ring 32, and wherein the inlet and outlet is arranged radially in the side surface 32b. The inlet 81 has a connection 83 to a sealing liquid reservoir 85. Sealing liquid and its reservoir is conventionally used in mechanical seals. The mechanical seal is opened wider by applying a higher pressure from the sealing liquid, and by applying a lower pressure from the sealing liquid the mechanical seal is opened to a smaller extent.

Alternatively, the pressure source 70 can be a negative pressure generator such that the pressurizable compartment 60 comprises vacuum. Thereby a “negative” pressure force is created, so that the resulting force goes in an opposite direction forcing the sealing surfaces 31a, 32a apart, leading to a gap between the sealing surfaces 31a, 32a.

In the compartment 60 a spring 62 is arranged.

FIG. 3b shows the mechanical seal 30 arranged in connection to the outlet chambers 6, 7 at the top of the centrifuge bowl 5. In this further embodiment the sealing liquid channel 80 has an axial extension, such that the inlet passes through the pressurizable compartment 60 and the stationary sealing ring 32. The inlet 81 of the sealing liquid channel 80 has a connection 83 to a sealing liquid reservoir 85. The sealing liquid channel 80 is a tightly sealed connection between the sealing liquid reservoir 85 and the stationary sealing ring 32, so that there is no connection to the pressurizable compartment 60 and its pressure source 70.

The pressurizable compartment 60 is arranged for transmitting a pressure force to the stationary sealing ring 32. As described in relation to FIG. 3a the compartment 60 is arranged above and in close contact with the stationary sealing ring 32. Thereby the contact force between the sealing surfaces 31a, 32a is achieved and is actively dynamically adjustable during operation. The stationary sealing ring 32 has a side surface 32b that forms an angle with the second sealing surface 32a.

Further components in FIG. 3b being corresponding components to those in FIG. 3a. Also they have the same functionality and thus the description in relation to FIG. 3a is also applicable to FIG. 3b.

FIG. 4 shows the mechanical seal 30 when used as an outlet so that a liquid passage is formed between the sealing surfaces 31a, 32a and arranged in connection to the outlet chambers 6, 7 at the top of the centrifuge bowl 5. As in FIGS. 3a and 3b the sealing is arranged between an inner zone, iz, defined by the outlet chambers 6, 7 and an outer zone, oz, defined by a volume 8 outside the bowl 5. The inner zone is located radially inside and extends axially through the sealing rings 31, 32 and the outer zone is arranged radially outside the sealing rings 31, 32, and wherein both the inner zone, iz, and the outer zone, oz, form part of a liquid passage. Liquid of higher density, indicated by arrow “B”, is discharged via the first outlet chamber 6 and further discharged through the interface between the rotatable and the stationary sealing rings 31, 32 to the outer zone.

The contact force between the sealing surfaces 31a, 32a is dynamically adjusted in order to create an axial gap that lets liquid in the inner zone pass to the outer zone. The adjustment of the contact force is regulated by the pressurizable compartment 60 likewise as discussed in relation to FIGS. 3a and 3b. Also, the sealing liquid chamber 85 and related parts of the sealing liquid have the corresponding functionality as has been described in relation to FIG. 3a.

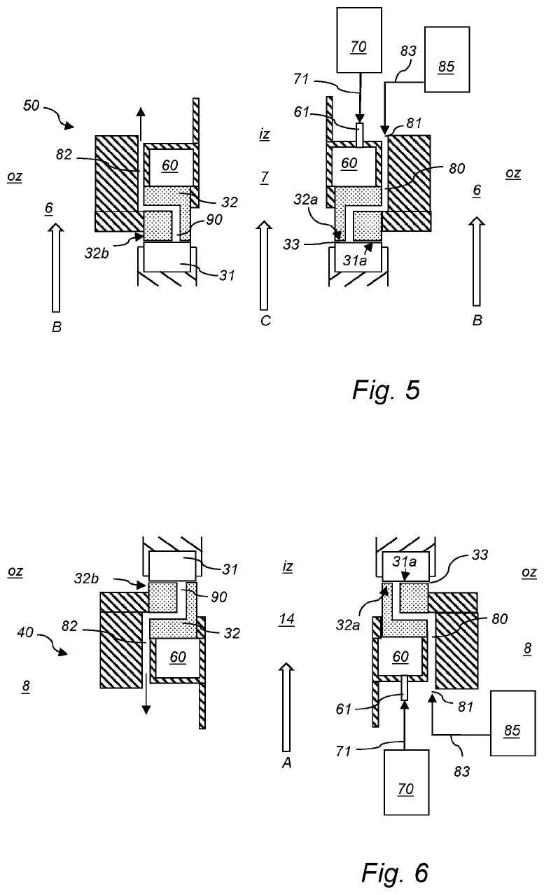

FIG. 5 discloses the mechanical seal 50 arranged in connection to the outlet chambers 6, 7 at the top of the centrifuge bowl 5. The sealing is arranged between an inner zone, iz, defined by the outlet chamber 7 (for a liquid of lighter density) and an outer zone, oz, defined by the outlet chamber 6 (for a liquid of higher density). The inner zone is located radially inside and extends axially through the sealing rings 31, 32 and the outer zone is arranged radially outside the sealing rings 31, 32. As in FIGS. 3a and 3b the mechanical seal 50 comprises a rotatable sealing ring 31 that is connected to the rotatable part 4 and a stationary sealing ring 32 that is connected to the stationary frame 2.

The rotatable sealing ring 31 has a first sealing surface 31a facing a second sealing surface 32a of the stationary sealing ring 32. The sealing surfaces 31a, 32a have a contact force between each other. A sealing interface 33 is formed between the rotatable and the stationary sealing rings 31, 32.

A pressurizable compartment 60 is arranged for transmitting a pressure force to the stationary sealing ring 32. The compartment 60 is arranged axially above and in close contact with the stationary sealing ring 32. Thereby the contact force between the sealing surfaces 31a, 32a is achieved and is dynamically adjustable during operation. The pressure source 70 for pressurizing the compartment 60 may be arranged axially above the pressurizable compartment 60.

The sealing liquid chamber 90 is arranged at the second sealing surface 32a, at the sealing interface 33 and radially within the stationary sealing ring 32, and the chamber 90 is connected to the sealing liquid channel 80.

The sealing liquid channel 80 is arranged within the stationary sealing ring 32 and comprises an inlet 81 and an outlet 82 to the stationary sealing ring 32, and wherein the inlet and outlet is arranged in an axial direction.

FIG. 6 shows the mechanical seal 40 arranged in connection to the inlet 14 at the lower part of the centrifuge bowl 5. The sealing is arranged between an inner zone, iz, defined by the inlet 14 (receiving the liquid feed mixture) and an outer zone, oz, defined by a volume 8 outside the bowl 5. As in the figures described above the mechanical seal 40 comprises a rotatable sealing ring 31 that is connected to the rotatable part 4 and a stationary sealing ring 32 that is connected to the stationary frame 2.

The rotatable sealing ring 31 has a first sealing surface 31a facing a second sealing surface 32a of the stationary sealing ring 32. The sealing surfaces 31a, 32a have a contact force between each other. A sealing interface 33 is formed between the rotatable and the stationary sealing rings 31, 32.

A pressurizable compartment 60 is arranged for transmitting a pressure force to the stationary sealing ring 32. The compartment 60 is arranged axially below and in close contact with the stationary sealing ring 32. Thereby the contact force between the sealing surfaces 31a, 32a is achieved and is dynamically adjustable during operation. The pressure source 70 for pressurizing the compartment 60 may be arranged axially below the pressurizable compartment 60.

The sealing liquid chamber 90 is arranged at the second sealing surface 32a, at the sealing interface 33 and radially within the stationary sealing ring 32, and the chamber 90 is connected to the sealing liquid channel 80.

The sealing liquid channel 80 is arranged within the stationary sealing ring 32 and comprises an inlet 81 and an outlet 82 to the stationary sealing ring 32, and wherein the inlet and outlet is arranged in an axial direction.

Also, for FIGS. 5 and 6, the sealing liquid chamber 85 and related parts of the sealing liquid have the corresponding functionality as have been described in relation to FIG. 3a.

Alternatively, the sealing liquid chamber 90 may be arranged radially outside of the stationary sealing ring (32 (this is not shown in the figures).

The invention is not limited to the embodiment disclosed but may be varied and modified within the scope of the claims set out below. The invention is not limited to the type of separator as shown in the Figures. The term “centrifugal separator” also comprises centrifugal separators with a substantially horizontally oriented axis of rotation and separator having a single liquid outlet.

1. A centrifugal separator for separating at least one liquid phase from a liquid feed mixture, comprising
a stationary frame, a drive member and a rotating part,
wherein the drive member is configured to rotate the rotatable part in relation to the stationary frame around an axis of rotation,
wherein the rotatable part comprises a centrifuge bowl enclosing a separation space,
wherein the centrifuge bowl further comprises an inlet for receiving the liquid feed mixture and at least one liquid outlet, for discharging a separated liquid phase,
wherein the centrifugal separator further comprises a mechanical seal for sealing between the rotatable part and the stationary frame during operation, the mechanical seal, comprising
a rotatable sealing ring connected to the rotatable par; and
a stationary sealing ring connected to the stationary frame;
wherein the mechanical seal, provides a seal between an inner zone and an outer zone and wherein the inner zone is located radially inside and extends axially through the sealing rings and the outer zone is arranged radially outside the sealing rings,
wherein the rotatable sealing ring comprises at least one first sealing surface and the stationary sealing comprises at least one second sealing surface, which sealing surfaces having a contact force between each other and forming at least one sealing interface between the rotatable and the stationary sealing rings during operation, and
wherein the mechanical seal is arranged in the separator such that said contact force of the mechanical seal is actively dynamically adjustable in a substantially axial direction during operation.

2. The centrifugal separator according to claim 1, further comprising:
a pressurizable compartment being arranged axially in relation to the sealing rings,
wherein the pressurizable compartment is arranged for transmitting a pressure force to the stationary sealing ring such that the contact force between the sealing surfaces is actively dynamically adjustable during operation.

3. The centrifugal separator according claim 1, wherein a liquid outlet defines the inner zone and a volume outside the centrifuge bowl defines the outer zone.

4. The centrifugal separator according to claim 1, wherein the centrifuge bowl has a first liquid outlet for discharging a liquid heavy phase and a second liquid outlet for discharging a liquid light phase, and
wherein the second liquid outlet defines the inner zone and the first liquid outlet defines the outer zone.

5. The centrifugal separator according to claim 1, wherein both the inner zone and the outer zone form part of a liquid passage, and
wherein the mechanical seal is arranged such that the contact force between the sealing surfaces is dynamically adjusted to form an axial gap to allow liquid in the inner zone to be discharged through said gap to the outer zone.

6. The centrifugal separator according to claim 1, wherein the rotatable part comprises a drive spindle having an inlet channel for supply of said liquid feed mixture to said inlet, and
wherein the inner zone is the inlet channel, and the outer zone is volume outside the drive spindle.

7. The centrifugal separator according to claim 2, wherein the mechanical seal further comprises a sealing liquid chamber at the sealing interface,
wherein the centrifugal separator further comprises a sealing liquid channel for a supply of sealing liquid to said sealing liquid chamber, and
wherein the sealing liquid channel is separate from the pressurizable compartment and its connection to a pressure source.

8. The centrifugal separator according to claim 7, wherein the sealing liquid chamber is arranged in the second sealing surface at the sealing interface and radially within the stationary sealing ring such that a double contact seal is formed by the rotatable and stationary sealing rings.

9. The centrifugal separator according to claim 7, wherein the stationary sealing ring comprises a side surface forming an angle with the second sealing surface,
wherein the sealing liquid channel is arranged within the stationary sealing ring and comprises an inlet and an outlet to the stationary sealing ring, and
wherein the inlet and/or outlet is arranged in the side surface.

10. The centrifugal separator according to claim 7, wherein the sealing liquid channel is arranged radially outside of the stationary sealing ring.

11. The centrifugal separator according to claim 7, wherein the sealing liquid channel is arranged axially outside of the stationary sealing ring.

12. The centrifugal separator according to claim 2, further comprising:
spring arranged in force transmitting connection to both the pressurizable compartment and said stationary sealing-ring ring,
wherein the spring is arranged to move in an axial direction to adjust the contact force between the sealing surfaces.

13. The centrifugal separator according to claim 2, further comprising:
a pressure source connected to the pressurizable compartment.

14. A The centrifugal separator according to claim 1, wherein the media of the pressure source is a gas or a liquid for pressurizing the compartment.

15. The centrifugal separator according claim 2, further comprising:
a negative pressure generator connected to the pressurizable compartment.

16. The centrifugal separator according to claim 2, wherein a liquid outlet defines the inner zone and a volume outside the centrifuge bowl defines the outer zone.

17. The centrifugal separator according to claim 2, wherein the centrifuge bowl has a first liquid outlet for discharging a liquid heavy phase and a second liquid outlet for discharging a liquid light phase, and wherein the second liquid outlet defines the inner zone and the first liquid outlet defines the outer zone.

18. The centrifugal separator according to claim 2, wherein both the inner zone and the outer zone form part of a liquid passage, and
wherein the mechanical seal is arranged such that the contact force between the sealing surfaces is dynamically adjusted to form an axial gap to allow liquid in the inner zone to be discharged through said gap to the outer zone.

19. The centrifugal separator according to claim 3, wherein both the inner zone and the outer zone form part of a liquid passage, and
wherein the mechanical seal is arranged such that the contact force between the sealing surfaces is dynamically adjusted to form an axial gap to allow liquid in the inner zone to be discharged through said gap to the outer zone.

20. The centrifugal separator according to claim 4, wherein both the inner zone and the outer zone form part of a liquid passage, and
wherein the mechanical seal is arranged such that the contact force between the sealing surfaces is dynamically adjusted to form an axial gap to allow liquid in the inner zone to be discharged through said gap to the outer zone.
